(19) United States
(12) Patent Application Publication
(10) Pub. No.: US 2024/0388010 A1
(43) Pub. Date: Nov. 21, 2024

(54) PATCH ANTENNA STRUCTURE, UWB ANTENNA, AND MULTI-LAYER ANTENNA SYSTEM

(71) Applicant: Shenzhen Sunway Communication Co., Ltd., Shenzhen (CN)

(72) Inventors: Heming Yu, Shenzhen (CN); Yuan Gu, Shenzhen (CN); Hongyan Yin, Shenzhen (CN)

(21) Appl. No.: 18/589,724

(22) Filed: Feb. 28, 2024

Related U.S. Application Data
(63) Continuation of application No. PCT/CN2023/123563, filed on Oct. 9, 2023.

(30) Foreign Application Priority Data
May 16, 2023 (CN) 202310553088.9

(51) Int. Cl. H01Q 21/06; H01Q 1/48; H01Q 9/04

(52) U.S. Cl. CPC H01Q 21/065; H01Q 1/48; H01Q 9/0407

(57) ABSTRACT

a patch antenna structure includes: a dielectric substrate, having a first surface and a second surface that face away from each other; a metal ground layer, attached to the first surface of the dielectric substrate and provided with a plurality of slots; and an array of antenna elements, composed of four antenna elements and disposed on the second surface of the dielectric substrate; wherein in the array of antenna elements, a spacing between centers of two adjacent antenna elements in a same row is less than a predetermined standard distance, and antenna elements in adjacent rows are arranged to mirror each other. The embodiments of the present disclosure are simple in structure and are applicable to various scenarios of indoor ultra-wideband base stations.

### CROSS-REFERENCE TO RELATED APPLICATIONS

This application is based upon and claims priority to Chinese Patent Application No. 202310553088.9, filed before China National Intellectual Property Administration on May 17, 2023 and entitled “PATCH ANTENNA, UWB ANTENNA, AND MULTI-LAYER ANTENNA SYSTEM,” the entire content of which is incorporated herein by reference.

### TECHNICAL FIELD OF THE INVENTION

Embodiments of the present disclosure relate to the technical field of antennas, and in particular, relate to a patch antenna structure, a UWB antenna, and a multi-layer antenna system.

### BACKGROUND OF THE INVENTION

Ultra-wideband (UWB) technology, as a focus of development in the market, will bring great convenience to people's daily life and work in the future. UWB technology has merits including accurate positioning, security, anti-interference, low power consumption, a short-range high-speed data transmission. In the future, UWB has the prospect of being extensively applied in things of Internet, smart home, security, and the like fields, and implements such functions as real-time positioning and searching, payments, security door locks, automobile digital keys, and the like. With constant perfection of the UWB ecological chain, UWB modules and UWB-tags will be more and more extensively applied.

In the scenario of accurate positioning and coverage, UWB has the characteristics of lower power spectral density, insensitivity to channel fading, low transmit power, strong anti-interference capability, large system capacity, high resolution, and the like. Therefore, UWB is particularly suitable for wireless access in dense multi-path positioning sites in scenarios of indoor access. Conventional UWB antennas are typically circularly polarized antennas or linearly polarized antennas. However, in practice, these antennas may all be subject to test dead zones.

### SUMMARY OF THE INVENTION

Embodiments of the present disclosure employ one technical solution of a patch antenna structure. The patch antenna structure includes: a dielectric substrate, having a first surface and a second surface that face away from each other; a metal ground layer, attached to the first surface of the dielectric substrate and provided with a plurality of slots; and an array of antenna elements, composed of four antenna elements and disposed on the second surface of the dielectric substrate; wherein in the array of antenna elements, a spacing between centers of two adjacent antenna elements in a same row is less than a predetermined standard distance, and antenna elements in adjacent rows are arranged to mirror each other.

In some embodiments, the antenna element includes: a first rectangular radiator, having predetermined dimensions; wherein the first rectangular radiator is provided with a chamfer having a square shape at each of two vertexes in a diagonal direction to form a perturbation construction.

In some embodiments, the antenna element includes: a second rectangular radiator, having predetermined dimensions; and a vacant slot, disposed in the second rectangular radiator and extending along a diagonal direction of the second rectangular radiator.

In some embodiments, the antenna element includes: a rectangular coupler, provided with a chamfer having an isosceles triangular shape at each of two vertexes in a diagonal direction of the rectangular coupler; and a circular radiator, disposed in the rectangular coupler and having a gap with a predetermined width from the rectangular coupler.

In some embodiments, a feed point of the antenna element is at a center of circle of the circular radiator.

In some embodiments, the metal ground layer is in a rectangular shape, and has a first edge, a second edge, a third edge, and a fourth edge; wherein the metal ground layer is provided with: a first rectangular slot parallel to the first edge and close to the first edge; a second rectangular slot parallel to the second edge and close to the second edge; a third rectangular slot parallel to the third edge and close to the third edge; and a fourth rectangular slot parallel to the fourth edge and close to the fourth edge; wherein the first rectangular slot and the third rectangular slot are rotatably symmetrically arranged about a center of the rectangular metal ground layer, and the second rectangular slot and the fourth rectangular slot are rotatably symmetrically arranged about a center of the rectangular metal ground layer.

In some embodiments, the predetermined standard distance is ½ of a wavelength of the patch antenna.

In some embodiments, the antenna element is fed via a metal through hole.

Embodiments of the present disclosure employ another technical solution of a UWB antenna. The UWB antenna includes three or more patch antenna structures as described above. Two adjacent patch antenna structures are connected via dielectric substrates thereof to enclose to form the UWB antenna; wherein second surfaces the dielectric substrates define an outer surface of the UWB antenna, and first surfaces of the dielectric substrates define an inner surface of the UWB antenna.

In some embodiments, the dielectric substrate is a rectangular substrate and has predetermined dimensions and a predetermined thickness; and the two adjacent patch antenna structures are connected via wide edges of the dielectric substrates to enclose to define a corresponding polyhedral structure; wherein the second surfaces of the dielectric substrates define an outer surface of the polyhedral structure, and the first surfaces of the dielectric substrates define an inner surface of the polyhedral structure.

Embodiments of the present disclosure employ still another technical solution of a multi-layer antenna system. The multi-layer antenna system includes two or more UWB antennas as described above. Two adjacent UWB antennas are stacked along a height direction to define the multi-layer antenna system.

### BRIEF DESCRIPTION OF DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic structural diagram of a patch antenna structure according to an embodiment of the present disclosure, wherein arrangement of antenna elements is illustrated;

FIG. 2 is a side structural diagram of the patch antenna structure according to an embodiment of the present disclosure;

FIG. 3 is a schematic structural diagram of the patch antenna structure according to an embodiment of the present disclosure, wherein arrangement of rectangular slots are illustrated;

FIG. 4 is a schematic circuit diagram of an antenna element according to an embodiment of the present disclosure;

FIG. 5 is a schematic circuit diagram of another antenna element according to an embodiment of the present disclosure;

FIG. 6 is a graph of a parameter S11 when the antenna element operates in a CH5 frequency band;

FIG. 7 is a graph of the parameter S11 when the patch antenna structure operates in the CH5 frequency band;

FIG. 8 is a graph of a parameter S11 when the antenna element operates in a CH9 frequency band;

FIG. 9 is a graph of the parameter S11 when the patch antenna structure operates in the CH9 frequency band;

FIG. 10 is a graph of a parameter S21 when the antenna element operates in the CH5 frequency band;

FIG. 11 is a graph of the parameter S21 when the patch antenna structure operates in the CH5 frequency band;

FIG. 12 is a graph of the parameter S21 when the antenna element operates in the CH9 frequency band;

FIG. 13 is a graph of the parameter S21 when the patch antenna structure operates in the CH9 frequency band;

FIG. 14 is a diagram illustrating a radiation direction when the antenna element operates at 6.5 GHz;

FIG. 15 illustrates a radiation pattern when the patch antenna structure operates at 6.5 GHz;

FIG. 16 illustrates a radiation pattern when the antenna element operates at 8.0 GHz;

FIG. 17 illustrates a radiation pattern when the patch antenna structure operates at 8.0 GHz;

FIG. 18 is a schematic circuit diagram of a UWB antenna according to an embodiment of the present disclosure;

FIG. 19 illustrates a radiation pattern when the UWB antenna operates at 6.5 GHz;

FIG. 20 illustrates a radiation pattern when the UWB antenna operates at 8.0 GHz;

FIG. 21 is a schematic structural diagram of a multi-layer antenna system according to an embodiment of the present disclosure;

FIG. 22 illustrates a radiation pattern when the multi-layer antenna system operates at 6.5 GHz; and

FIG. 23 illustrates a radiation pattern when the multi-layer antenna system operates at 8.0 GHz.

### DETAILED DESCRIPTION OF THE INVENTION

For clearer descriptions of the objectives, technical solutions, and advantages of the embodiments of the present disclosure, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

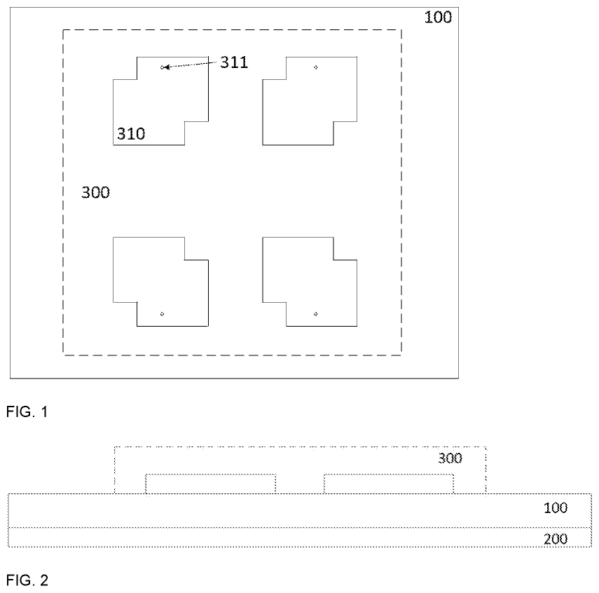

According to an embodiment of the present disclosure, as illustrated in FIG. 2, an antenna system may include: dielectric substrate 100 having a first surface and a second surface that facing away from each other, a metal ground layer 200 attached on the first surface of the dielectric substrate 100, and an array of antenna elements 300 disposed on the second surface of the dielectric substrate 100.

The dielectric substrate refers to a plate-shaped dielectric medium that is configured to secure an antenna element to a stable environment to ensure proper mounting and operations of the antenna element, or configured to connect the antenna element to the array of antenna elements to achieve adjustments of frequency and orientation. The specific shape and dimensions of the dielectric substrate may be determined according to actual needs.

For ease of description, in this embodiment and embodiments hereinafter, the dielectric substrate 100 is generally designated as a rectangular FR4 substrate having predetermined dimensions and a predetermined thickness, with a long edge length of 100 mm, a short edge length of 100 mm, and a thickness of 2 mm.

According to an embodiment of the present disclosure, the array of antenna elements 300 is composed of four antenna elements, as illustrated in FIG. 1.

Each of the antenna elements is provided with a corresponding feed point, such that an excitation signal generates a current in both the antenna element and the metal ground layer. In this embodiment, the antenna element is fed via a metal through hole disposed at the corresponding feed point.

In accordance with the cavity mode theory, when a regularly-shaped micro-strip antenna is fed by one point, two degenerate modes with orthogonal polarization and equal amplitudes may be generated; however, a 90-degree phase difference fails to be achieved. However, circular polarization may be achieved where an equivalent impedance phase angle in one mode is advanced by 45 degrees whereas an equivalent impedance phase angle in another mode is lagged by 45 degrees by introducing an unit with a separable degenerate mode onto a regular patch.

According to an embodiment of the present disclosure, a regular antenna element is arranged, and perturbation is introduced to derive a relatively changed area, such that circular polarization is achieved. Specifically, the antenna element is defined as a first rectangular radiator 310 having a predetermined edge length. The first rectangular radiator 310 is provided with a chamfer having a square shape at each of two vertexes in a diagonal direction to form a perturbation construction, wherein the perturbation constructions are respectively an upper left chamfer and a lower right chamfer. The feed point is arranged at an intersection between a horizontal axis of symmetry of the upper left chamfer and a vertical axis of symmetry of the first rectangular radiator 310.

The dimensions of the first rectangular radiator, the shapes and positions of the chamfers, the position of the feed point may be adjusted according to actual application needs to change parameters such as a resonance frequency range, an axial ratio, and an efficiency of the antenna.

In addition, based on a single-fed antenna element applying the introduced perturbation, an array transmitter is further employed to control excitation phases and amplitudes between the antenna elements by rotational symmetrical arrangement of the array of antenna elements, which allows circular polarization in a total radiation field of the array.

Specifically, in the array of antenna elements 300, the four antenna elements are arranged in two rows and two columns, and a spacing between centers of two adjacent antenna elements in a same row is less than a predetermined standard distance. In some embodiments, the predetermined standard distance may be ½ of a wavelength of the patch antenna.

Antenna elements in adjacent rows are arranged to mirror each other. That is, the antenna elements in a first row and the antenna elements in a second row are in a symmetric mirror configuration, and the feed points of the antenna elements in two adjacent rows are also in a symmetric mirror configuration. In this way, a qualified axial ratio bandwidth is achieved in a frequency band range, and thus the effect of broadband radiation and reception is achieved. The four antenna elements may simultaneously support 1T3R, 2T2R, and the like hardware operating mode, which may also be adjusted according to actual application needs.

It should be noted that an endpoint trajectory of an instantaneous electric field vector of any polarized wave is an ellipse. A ratio of a major axis 2A of the ellipse to a minor axis 2B of the ellipse is referred to as an axial ratio (AR). The axial ratio bandwidth is an operating frequency band of an antenna whose axial ratio is less than a predetermined value in a primary radiation direction or in a beam width. Assuming that an impedance bandwidth of a circularly polarized antenna having a standing wave ratio less than 1.5 is 50 MHz, and within this frequency band, the frequency band whose axial ratio is less than a predetermined value (for example, 10 dB) in the entire primary beam is only 10 MHz, then the axial ratio bandwidth of the antenna is 10 MHz.

In the embodiments of the present disclosure, the axial ratio bandwidth is defined as a bandwidth whose axial ratio is not greater than 10 dB.

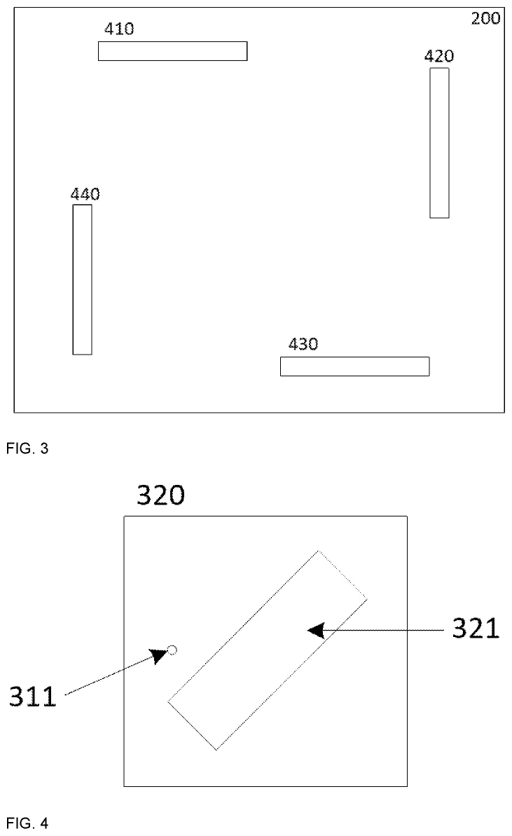

According to an embodiment of the present disclosure, a plurality slots are defined in the metal ground layer 200 to change distribution of electromagnetic waves on the ground layer and improve consistency of the radiation directions of the antennas, as illustrated in FIG. 3.

It should be noted that the shape and dimensions of the dielectric substrate 100 in this embodiment are defined according to the dimensions of the metal ground layer 200. In other words, the metal ground layer 200 is in a rectangular shape, and has a first edge, a second edge, a third edge, and a fourth edge.

The metal ground layer 200 is provided with a first rectangular slot 410 parallel to the first edge and close to the first edge, a second rectangular slot 420 parallel to the second edge and close to the second edge, a third rectangular slot 430 parallel to the third edge and close to the third edge, and a fourth rectangular slot 440 parallel to the fourth edge and close to the fourth edge. The first rectangular slot 410, the second rectangular slot 420. The third rectangular slot 430, and the fourth rectangular slot 440 have the same dimensions.

It should be emphasized that the first rectangular slot 410 and the third rectangular slot 430 are rotatably symmetrically arranged about a center of the rectangular metal ground layer 200, and the second rectangular slot 420 and the fourth rectangular slot 440 are rotatably symmetrically arranged about a center of the rectangular metal ground layer 200.

In some other embodiments, the dimensions and positions of the first rectangular slot, the second rectangular slot, the third rectangular slot, and the fourth rectangular slot may be adjusted according to actual needs.

Exemplarily, FIG. 4 is a schematic structural diagram of another antenna element according to an embodiment of the present disclosure. The antenna element is defined as a regular second rectangular radiator 320 having a predetermined edge length. The second rectangular radiator is provided with a rectangular vacant slot 321. The rectangular vacant slot 321 extends along a diagonal direction of the second rectangular radiator. The feed point 311 is arranged at a horizontal axis of symmetry of the second rectangular radiator, and disposed on a side of the rectangular vacant slot 321.

The dimensions of the second rectangular radiator and the rectangular vacant slot, and the position of the feed point may be adjusted according to actual needs.

Exemplarily, FIG. 5 is a schematic structural diagram of another antenna element according to an embodiment of the present disclosure. The antenna element includes a circular radiator 330 having a predetermined diameter, and further includes a rectangular coupler 331 having a predetermined edge length.

The rectangular coupler 331 is provided with a chamfer having an isosceles triangular shape at each of two vertexes in a diagonal direction thereof. The circular radiator 330 is disposed in the rectangular coupler 331 and has a gap with a predetermined width from the rectangular coupler 331. The feed point is disposed at a center of circle of the circular radiator 330.

The dimensions of circular radiator and the rectangular coupler, the width of the gap, and the position of the feed point may be adjusted according to actual needs.

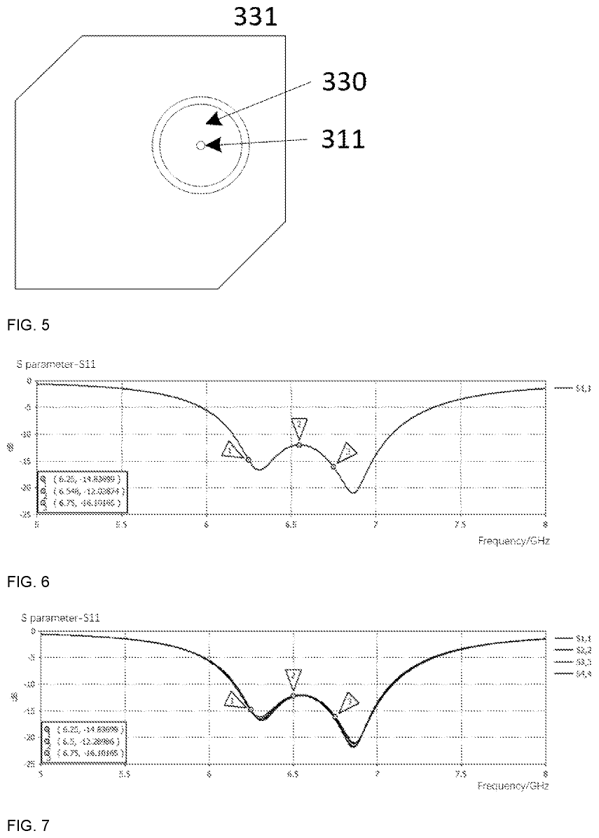

Exemplarily, FIG. 6 is a graph of a parameter S11 when an individual antenna element in a patch antenna structure operates in a CH5 frequency band (6.25 GHz to 6.75 GHz) according to an embodiment of the present disclosure. As illustrated in FIG. 6, within this frequency band, S11 of the antenna element is less than 10 dB. This indicates that impedance changes of the antenna within this frequency band are within an allowable range, that is, a reflection coefficient of a port of the antenna within this frequency band is less than a predetermined value, that is, 10 dB. S11 of the antenna element within the CH5 frequency band satisfies the predetermined requirement. Therefore, the CH5 frequency band is considered as a bandwidth of the antenna element.

FIG. 7 is a graph of a parameter S11 when antenna elements in the patch antenna structure operate in the CH5 frequency band (6.25 GHz to 6.75 GHz) according to an embodiment of the present disclosure. As illustrated in FIG. 7, curves are substantially coincident with each other, that is, the bandwidths of the antenna elements are consistent.

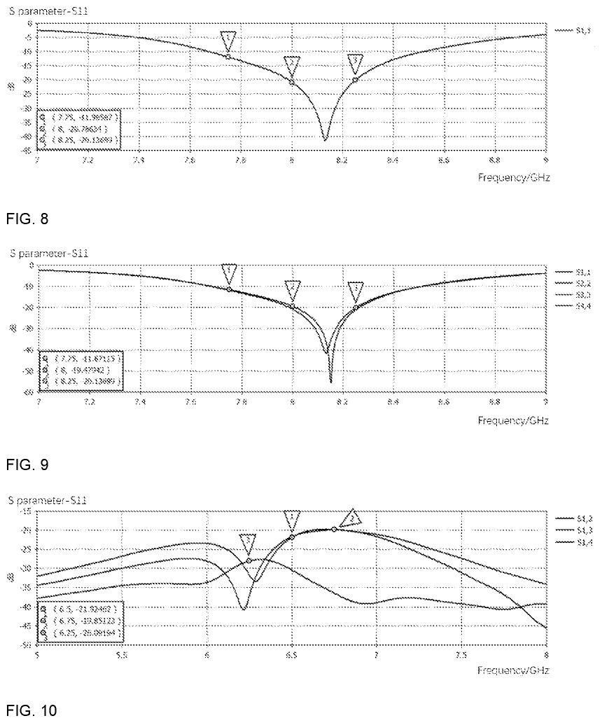

FIG. 8 is a graph of the parameter S11 when an individual antenna element in the patch antenna structure operates in a CH9 frequency band (7.75 GHz to 8.25 GHz) according to an embodiment of the present disclosure. As illustrated in FIG. 8, within this frequency band, S11 of the antenna element is less than 10 dB. Analogously, the CH9 frequency band is considered as a bandwidth of the antenna element.

FIG. 9 is a graph of a parameter S11 when antenna elements in the patch antenna structure operate in the CH9 frequency band (7.75 GHz to 8.25 GHz) according to an embodiment of the present disclosure. As illustrated in FIG. 9, curves are substantially coincident with each other, that is, the bandwidths of the antenna elements are consistent.

FIG. 10 is a graph of a parameter S21 when the patch antenna structure operates in the CH5 frequency band (6.25 GHz to 6.75 GHz) according to an embodiment of the present disclosure. As illustrated in FIG. 10, the antenna element is used as a transmit antenna, and the other three antenna elements are used as receive antennas.

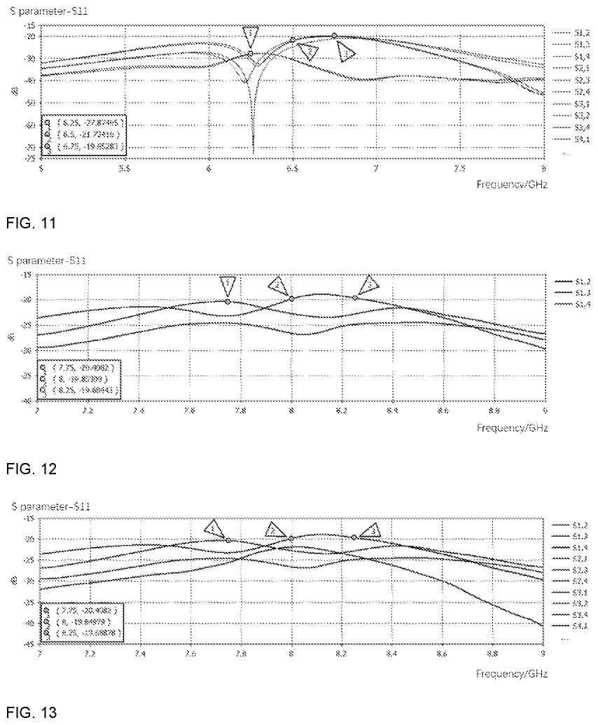

FIG. 11 is a graph of the parameter S21 when the patch antenna structure operates in the CH5 frequency band (6.25 GHz to 6.75 GHz) according to an embodiment of the present disclosure. As illustrated in FIG. 11, any antenna element is used as a transmit antenna, and the other three antenna elements are used as receive antennas.

Exemplarily, FIG. 12 is a graph of the parameter S21 when an individual antenna element in the patch antenna structure operates in the CH9 frequency band (7.75 GHz to 8.25 GHz) according to an embodiment of the present disclosure. As illustrated in FIG. 12, the antenna element is used as a transmit antenna, and the other three antenna elements are used as receive antennas.

FIG. 13 is a graph of the parameter S21 when the patch antenna structure operates in the CH9 frequency band (7.75 GHz to 8.25 GHz) according to an embodiment of the present disclosure. As illustrated in FIG. 13, any antenna element is used as a transmit antenna, and the other three antenna elements are used as receive antennas.

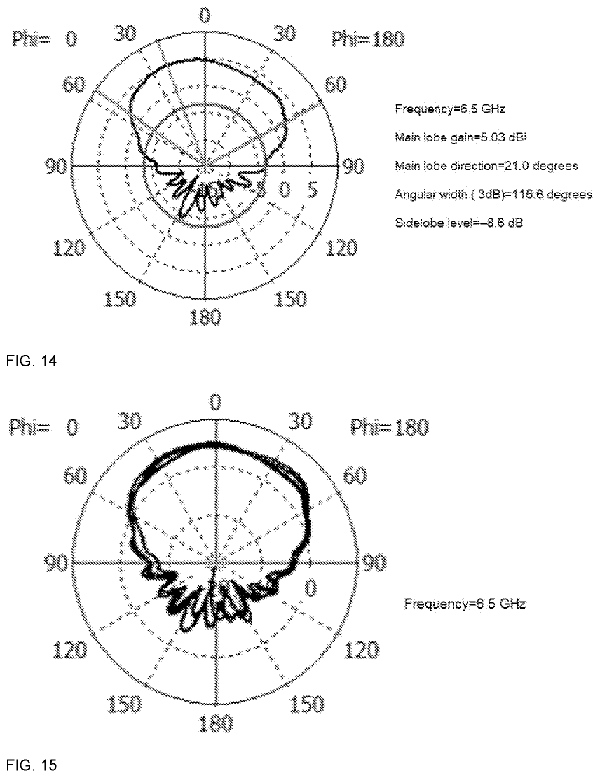

FIG. 14 illustrates a radiation pattern when an individual antenna element in the patch antenna structure operates at 6.5 GHz according to an embodiment of the present disclosure. As illustrated in FIG. 14, gains at different radiation angles of the antenna element when operating at the frequency are indicated. It is apparent that a maximum gain of antenna element when operating at 6.5 GHz is 5.03 dBi, a position corresponding to the maximum gain is a main lobe direction, and a main lobe is at a position of 21.0 degree on the left. In the radiation pattern, an angular width of a radiation range with gains greater than 3 dB is 116.6 degrees, and a sidelobe level is −8.6 dB.

FIG. 15 illustrates a radiation pattern when antenna elements in the patch antenna structure operate at 6.5 GHz according to an embodiment of the present disclosure. As illustrated in FIG. 15, curves are substantially coincident with each other, that is, the bandwidths of the antenna elements are consistent.

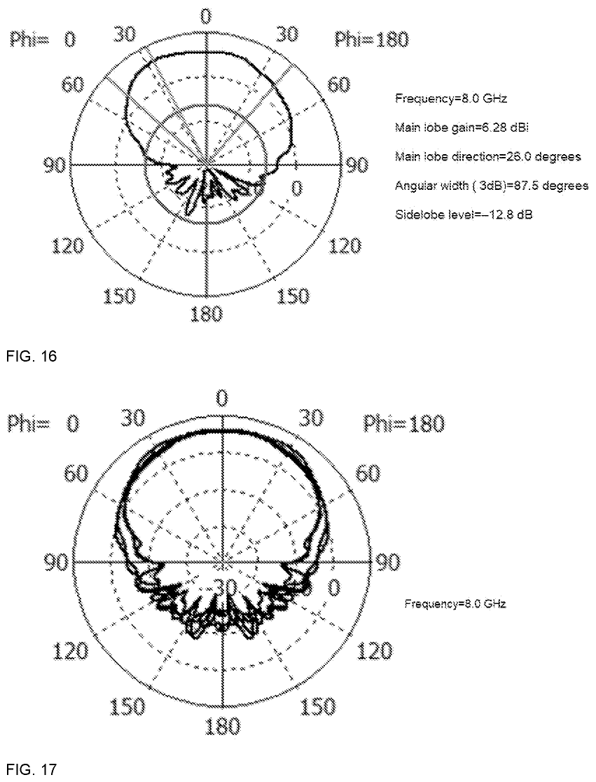

Exemplarily, FIG. 16 illustrates a radiation pattern when an individual antenna element in the patch antenna structure operates at 8.0 GHz according to an embodiment of the present disclosure. It is apparent that a main lobe gain of the antenna element when operating in the CH5 frequency band is 6.28 dBi, and a main lobe is at a position of 26.0 degree on the left. In the radiation pattern, an angular width of a radiation range with gains greater than 3 dB is 87.5 degrees, and a sidelobe level is −12.8 dB.

FIG. 15 illustrates a radiation pattern when antenna elements in the patch antenna structure operate at 8.0 GHz according to an embodiment of the present disclosure. As illustrated in FIG. 15, curves are substantially coincident with each other, that is, the bandwidths of the antenna elements are consistent.

Ultra-wideband (UWB) is a radio carrier communication technology that transmits information across a wide bandwidth over 1 GHz. UWB uses a nanosecond-level non-sinusoidal narrow pulse rather than a sinusoidal carrier to transmit data and thus spans a wide spectrum range. Although radio communication is used, the data transmission rate may reach over several 100 megabits/second. Using UWB, signals are transmitted over a very high bandwidth. The U.S. Federal Communications Commission (FCC) stipulates UWB as using a bandwidth exceeding 500 MHz in the frequency band range from 3.1 to 10.6 GHz.

In the simulation diagram of the above embodiments, an operating frequency band of a patch antenna is illustrated. It is apparent that the patch antenna uses a frequency exceeding 500 MHz in the frequency band range from 3.1 to 10.6 GHz. Therefore, the patch antenna is applicable to UWB.

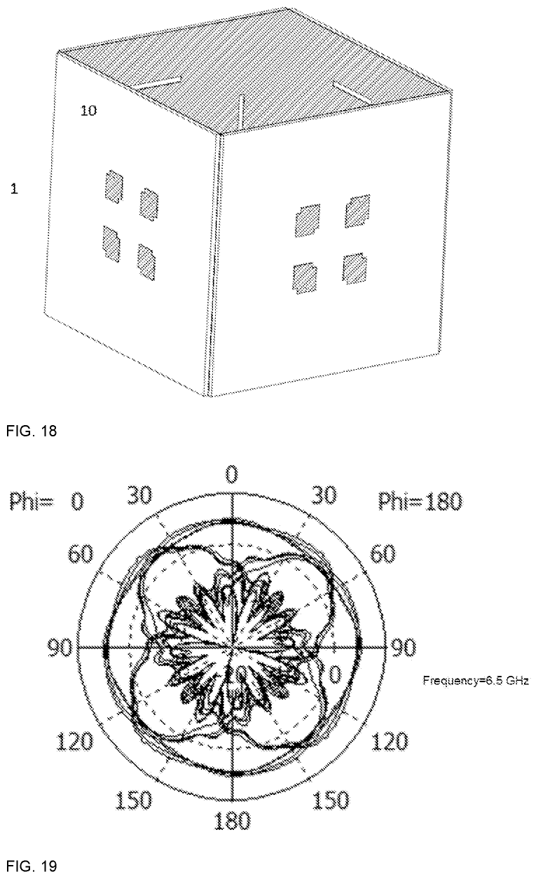

Hereinafter, with reference to the drawings of the present disclosure, using the patch antenna as illustrated in FIG. 1, FIG. 2, and FIG. 3 as an example, a UWB antenna is provided. FIG. 18 illustrates a schematic structural diagram of the UWB antenna.

The UWB antenna includes three or more than three patch antenna structures, for example, three patch antenna structures 10 according to the above embodiments. Two adjacent patch antenna structures 10 are connected via the dielectric substrates of the patch antenna structures 10 to enclose to define a UWB antenna 1.

Second surfaces the dielectric substrates define an outer surface of the UWB antenna 1, and first surfaces of the dielectric substrates define an inner surface of the UWB antenna 1.

Specifically, in the embodiments of the present disclosure, the dielectric substrate is in a rectangular shape having predetermined dimensions. Two adjacent patch antenna structures 10 are connected via wide edges of the dielectric substrates to enclose to define a corresponding tetrahedral structure.

The second surfaces of the dielectric substrates define an outer surface of the tetrahedral structure, and the first surfaces of the dielectric substrates define an inner surface of the tetrahedral structure.

It should be noted that the structure of the UWB antenna may be adjusted according to actual needs in application scenarios, that is, an application frequency or coverage range, to form a trihedral, tetrahedral, or pentahedral structure.

For example, in the above embodiments, when the antenna elements of the patch antenna structure operate at 6.5 GHz, the angular width of the radiation range with gains greater than 3 dB is 116.6 degrees. Therefore, for a 360-degree coverage of the antenna, it is preferable that the UWB antenna is a tetrahedral structure.

UWB is mainly used for high-precision positioning. In actual application scenarios, UWB positioning tags repeatedly and uninterruptedly transmit data frames over UWB pulses; a UWB base station receives the UWB pulses over the UWB antenna and transmits the received pulses to the UWB base station; the UWB base station measures, using a high-precision short pulse detector, the time the data frames of each of the UWB positioning tags reach a receive antenna; a positioning engine determines, based on calibration data, differences of time that the UWB positioning tags reach different positioning base stations, and calculates positions of the tags using the three-point positioning technique and related optimization algorithms. Therefore, for reliable receiving the UWB pulses, the UWB antenna should have a 360-degree receiving surface.

FIG. 19 illustrates a radiation pattern when a tetrahedral UWB antenna operates at 6.5 GHz according to an embodiment of the present disclosure. It is apparent that the gain of the UWB antenna at any position is greater than 3 dB, and the UWB antenna has a good consistency of the radiation pattern.

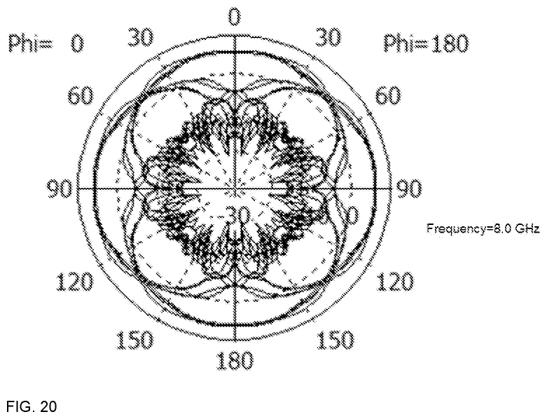

FIG. 20 illustrates a radiation pattern when the tetrahedral structure UWB antenna operates at 8.0 GHz according to an embodiment of the present disclosure. Likewise, it is apparent that the gain of the UWB antenna at any position is greater than 3 dB, but the UWB antenna has a poor consistency of the radiation pattern compared with that when the antenna operates at 6.5 GHz.

In practical applications, the UWB antenna may be attached to the ceiling or vertically placed on the desk, and the performance of the antenna is not affected by the deployment location.

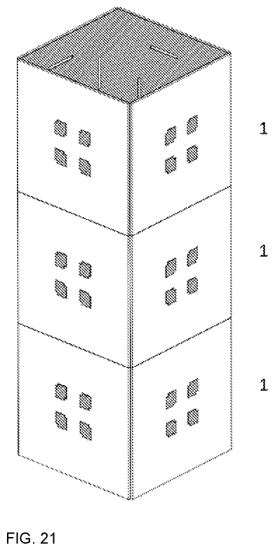

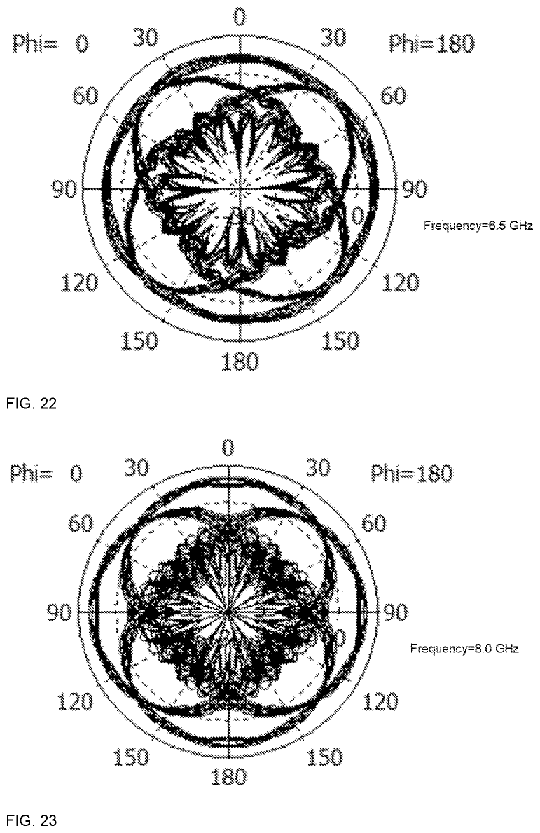

Hereinafter, with reference to the drawings the present disclosure, using the UWB antenna in FIG. 18 as an example, a multi-layer antenna system is provided. The multi-layer antenna system, based on the UWB antenna, improves the coverage, and increase the number of tracking tags. FIG. 21 illustrates a schematic structural diagram of the multi-layer antenna system.

The multi-layer antenna system includes two or more UWB antennas 1 as described in the above embodiments. Two adjacent UWB antennas 1 are stacked along a height direction to define the multi-layer antenna system.

Specifically, using a three-layer antenna system as an example in FIG. 21, the UWB antennas 1 are stacked along a wide edge direction of the dielectric substrates to form the three-layer antenna system. In this system, whether the long edges of the dielectric substrates are connected is not limited while no gap is caused between a juncture of ant two adjacent UWB antennas. In this embodiment, description is given using the scenario the long edges of the dielectric substrates are connected as an example.

According to some other embodiments of the present disclosure, for improvement of the coverage and increase of the number of tracking tags, more UWB antennas may be stacked to form a multi-layer antenna system.

Exemplarily, FIG. 19 illustrates a radiation pattern when a three-layer antenna system operates at 6.5 GHz according to an embodiment of the present disclosure. It is apparent that the gain of the three-layer antenna system at any position is greater than 3 dB, and the UWB antenna has a good consistency of the radiation pattern.

Exemplarily, FIG. 20 illustrates a radiation pattern when the three-layer antenna system operates at 8.0 GHz according to an embodiment of the present disclosure. Likewise, it is apparent that the gain of the three-layer antenna system at any position is greater than 3 dB, but the UWB antenna has a poor consistency of the radiation pattern compared with that when the antenna operates at 6.5 GHz.

It should be noted that based on the design concepts and implementation principles of the present disclosure, any adjustments, replacements, or combinations that are made to the structures of the UWB antenna and the multi-layer antenna system according to the embodiments of the present disclosure shall fall within the scope of the present disclosure.

Different from the related art, the embodiments of the present disclosure are simple in structure and are applicable to various scenarios of indoor ultra-wideband base stations. According to the technical solutions according to the embodiments of the present disclosure, precision of the ranging algorithm of an ultra-wideband system is improved, and a 360-degree coverage is achieved. In addition, a coverage rate is improved by multi-layer stacking, and the number of tracking tags is increased.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A patch antenna structure, comprising:
a dielectric substrate, having a first surface and a second surface that face away from each other;
a metal ground layer, attached to the first surface of the dielectric substrate and provided with a plurality of slots; and
an array of antenna elements, composed of four antenna elements and disposed on the second surface of the dielectric substrate;
wherein in the array of antenna elements, a spacing between centers of two adjacent antenna elements in a same row is less than a predetermined standard distance, and antenna elements in adjacent rows are arranged to mirror each other.

2. The patch antenna structure according to claim 1, wherein the antenna element comprises: a first rectangular radiator, having predetermined dimensions; wherein the first rectangular radiator is provided with a chamfer having a square shape at each of two vertexes in a diagonal direction to form a perturbation construction.

3. The patch antenna structure according to claim 1, wherein the antenna element comprises: a second rectangular radiator, having predetermined dimensions; and a vacant slot, disposed in the second rectangular radiator and extending along a diagonal direction of the second rectangular radiator.

4. The patch antenna structure according to claim 1, wherein the antenna element comprises: a rectangular coupler, provided with a chamfer having an isosceles triangular shape at each of two vertexes in a diagonal direction of the rectangular coupler; and a circular radiator, disposed in the rectangular coupler and having a gap with a predetermined width from the rectangular coupler.

5. The patch antenna structure according to claim 4, wherein a feed point of the antenna element is at a center of circle of the circular radiator.

6. The patch antenna structure according to claim 1, wherein the metal ground layer is in a rectangular shape, and has a first edge, a second edge, a third edge, and a fourth edge;
wherein the metal ground layer is provided with: a first rectangular slot parallel to the first edge and close to the first edge; a second rectangular slot parallel to the second edge and close to the second edge; a third rectangular slot parallel to the third edge and close to the third edge; and a fourth rectangular slot parallel to the fourth edge and close to the fourth edge;
wherein the first rectangular slot and the third rectangular slot are rotatably symmetrically arranged about a center of the rectangular metal ground layer, and the second rectangular slot and the fourth rectangular slot are rotatably symmetrically arranged about a center of the rectangular metal ground layer.

7. The patch antenna structure according to claim 1, wherein the predetermined standard distance is ½ of a wavelength of the patch antenna.

8. The patch antenna structure according to claim 1, wherein the antenna element is fed via a metal through hole.

9. An ultra-wideband (UWB) antenna, comprising: at least three the patch antenna structure, wherein the patch antenna structure comprises: a dielectric substrate, having a first surface and a second surface that face away from each other;
a metal ground layer, attached to the first surface of the dielectric substrate and provided with a plurality of slots; and
an array of antenna elements, composed of four antenna elements and disposed on the second surface of the dielectric substrate;
wherein in the array of antenna elements, a spacing between centers of two adjacent antenna elements in a same row is less than a predetermined standard distance, and antenna elements in adjacent rows are arranged to mirror each other;
wherein two adjacent patch antenna structures are connected via dielectric substrates thereof to enclose to form the UWB antenna;
wherein second surfaces the dielectric substrates define an outer surface of the UWB antenna, and first surfaces of the dielectric substrates define an inner surface of the UWB antenna.

10. The UWB antenna according to claim 9, wherein the dielectric substrate is a rectangular substrate and has predetermined dimensions and a predetermined thickness; and the two adjacent patch antenna structures are connected via wide edges of the dielectric substrates to enclose to define a corresponding polyhedral structure; wherein the second surfaces of the dielectric substrates define an outer surface of the polyhedral structure, and the first surfaces of the dielectric substrates define an inner surface of the polyhedral structure.

11. The UWB antenna according to claim 9, wherein the antenna element comprises: a first rectangular radiator, having predetermined dimensions; wherein the first rectangular radiator is provided with a chamfer having a square shape at each of two vertexes in a diagonal direction to form a perturbation construction.

12. The UWB antenna according to claim 9, wherein the antenna element comprises: a second rectangular radiator, having predetermined dimensions; and a vacant slot, disposed in the second rectangular radiator and extending along a diagonal direction of the second rectangular radiator.

13. The UWB antenna according to claim 9, wherein the antenna element comprises: a rectangular coupler, provided with a chamfer having an isosceles triangular shape at each of two vertexes in a diagonal direction of the rectangular coupler; and a circular radiator, disposed in the rectangular coupler and having a gap with a predetermined width from the rectangular coupler.

14. The UWB antenna according to claim 13, wherein a feed point of the antenna element is at a center of circle of the circular radiator.

15. The UWB antenna according to claim 9, wherein the metal ground layer is in a rectangular shape, and has a first edge, a second edge, a third edge, and a fourth edge;
wherein the metal ground layer is provided with: a first rectangular slot parallel to the first edge and close to the first edge; a second rectangular slot parallel to the second edge and close to the second edge; a third rectangular slot parallel to the third edge and close to the third edge; and a fourth rectangular slot parallel to the fourth edge and close to the fourth edge;
wherein the first rectangular slot and the third rectangular slot are rotatably symmetrically arranged about a center of the rectangular metal ground layer, and the second rectangular slot and the fourth rectangular slot are rotatably symmetrically arranged about a center of the rectangular metal ground layer.

16. The UWB antenna according to claim 9, wherein the predetermined standard distance is ½ of a wavelength of the patch antenna.

17. The UWB antenna according to claim 9, wherein the antenna element is fed via a metal through hole.

18. A multi-layer antenna system, comprising: two or more UWB antennas according to claim 9; wherein two adjacent UWB antennas are stacked along a height direction to define the multi-layer antenna system.

19. A multi-layer antenna system, comprising: two or more UWB antennas according to claim 10; wherein two adjacent UWB antennas are stacked along a height direction to define the multi-layer antenna system.
